(19) United States
(12) Patent Application Publication
(10) Pub. No.: US 2023/0329144 A1
(43) Pub. Date: Oct. 19, 2023

(54) Weed Eater String Holder

(71) Applicant: Herman Joseph Lyons, III, Kansas City, MO (US)

(72) Inventor: Herman Joseph Lyons, III, Kansas City, MO (US)

(21) Appl. No.: 17/719,407

(22) Filed: Apr. 13, 2022

(51) Int. Cl. A01D 34/416

(52) U.S. Cl. CPC A01D 34/4166

(57) ABSTRACT

Embodiments disclose a utility model is related to a system that can provide complete formulation and solution for replacing the current disintegrated string with new string instantly. A device is proposed that holds spare weed eater string and attaches directly to the weed eater. Thus, allows weed eater operators to keep spare weed eater string in proximity of their weed eater in order to quickly replace empty weed eater spools. The assembly is designed to attach directly around the shaft of a typical weed eater and remain in place when the weed eater is and is not in use. Additionally, this invention may be used with straight, curved, gas powered, and cordless weed eaters. This innovative approach offers technically a feasible process able solution to obtain a solution in convenient manner.

### BACKGROUND

### Field of the Invention

Embodiments disclosed herein generally relate to methods, apparatus and systems for providing an assembly for the lawn industry and specifically a device that holds spare weed eater string and attaches directly to the weed eater.

### Description of the Related Art

Weed trimmers are popular lawn care items in use by both consumers and lawn care professionals. The most popular form of power weed trimmer is the gasoline or electric engine device wherein a motor drives a nylon cord in a rapid rotary fashion. The cord then strikes and cuts down thin stemmed vegetations, most typically grasses and other shrubs and weeds. Weed trimmers are made by many different manufacturers. Typical well-known brands are Echo®, Stanley Black & Decker® and those made by the Ryobi.

Various guards and weed trimming accessories exist in the prior art. For example, U.S. Pat. No. 5,657,542 issued to White, III et al. relates to a trimmer having an improved trimmer head including a spool having a core with ribs thereon. The design prevents contraction of the line from warping or otherwise damaging the spool.

U.S. Pat. No. 5,584,348 issued to Butler relates to a guard for a weed trimmer. The guard includes an arcuate ring fastened at each end to opposing sides of the trimmer housing. The ring in combination with the trimmer housing forms a completely circular horizontal guard around the periphery of the cutting circle.

U.S. Pat. No. 5,402,627 issued to Trompler et al. relates to a support ski for mounting to a line trimmer to support the trimmer above the ground.

U.S. Pat. No. 5,228,276 issued to Miller relates to an attachment for a line trimmer including a wheel that provides an edging blade.

U.S. Pat. No. 5,115,870 issued to Byrne relates to a trimmer having a guide and guard rotatably mounted inboard of the trimmer cutting head. The guide and guard provide dynamic trimmer indexing on a sidewalk edge for guiding the trimmer vertically and horizontally to form a straight turf edge.

U.S. Pat. No. 4,651,442 issued to Everts relates to a line guard for a weed trimmer designed to protect the weed trimmer operator.

There are multiple inventions that have been proposed art regarding brining an advancement and enhanced utility for weed eater devices. However, the utilization of these systems is currently accompanied by various issues. For instance, currently there are millions of weed eaters being used by homeowners and lawn care professionals to maintain lawns all across the world. Nearly all weed eaters require the use of weed eater string made of nylon. The weed eater spins the string very rapidly in a circular motion to cut grass. As users cut grass the string used by the weed eater disintegrates and requires that new string be added to the weed eater when all trimmer string has been used. Unless a user carries spare weed eater string on their persons, this nearly always means returning to the place where weed eater string is kept such as a garage, workshop or trailer to add new string to the weed eater.

Therefore a need exists for a novel assembly which improves the arrangements in similar field. The invention focuses on providing a system that can provide complete solution of the above-mentioned problem. The current invention discloses a device that holds spare weed eater string and attaches directly to the weed eater. This invention allows weed eater operators to keep spare weed eater string in proximity of their weed eater in order to quickly replace empty weed eater spools.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

It is a general object of the present invention to provide an improved form of assembly which relates to a technically and feasible process able to provide weed eater string on instant basis.

It is also the objective of the invention to provide a novel approach in developing the device that holds spare weed eater string and attaches directly to the weed eater.

It is moreover the objective of the invention to provide a method where instead of arranging a weed eater string from some time-consuming sources, the current disclosure allows weed eater operators to keep spare weed eater string in proximity of their weed eater in order to quickly replace empty weed eater spools.

It is also the objective of invention to provide a weed eater string holder that is connected to a weed eater and contains surplus weed eater string. Furthermore, it is desirable to have a device that also will hold weed eater string spools.

It is further the objective of this invention to allow weed eater string to be changed quickly without the traditional steps of returning to the garage, workshop or trailer to add weed eater string. The disclosed device advantageously fills these needs and addresses the aforementioned deficiencies by providing a solution to the challenges encountered by millions of people as it relates to changing weed eater string. This invention allows weed eating tasks to be completed quicker and more efficiently as the downtime associated with replacing trimmer string is reduced.

It is further the objective of the invention to provide a system, where a single process solution for developing economically viable, easy processable and complete accessible solution for the convenience and time saving solution is provided.

More specifically, it is the principal object of this invention to provide an architecture which is made of high-quality material and technology and maintains its effectiveness.

Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 is a perspective view of a trimmer string holder by itself without any string or the spool attached.

FIG. 2 is a perspective view of the trimmer string holder with lose string wrapped around it and without the spool.

FIG. 3 is a perspective view of the string holder holding only the spool of string and without lose string.

FIG. 4 is a perspective view of the trimmer string holder holding both lose string and the spool of string.

FIG. 5 shows the expanded view of weed eater devices as per preferred embodiments of the invention.

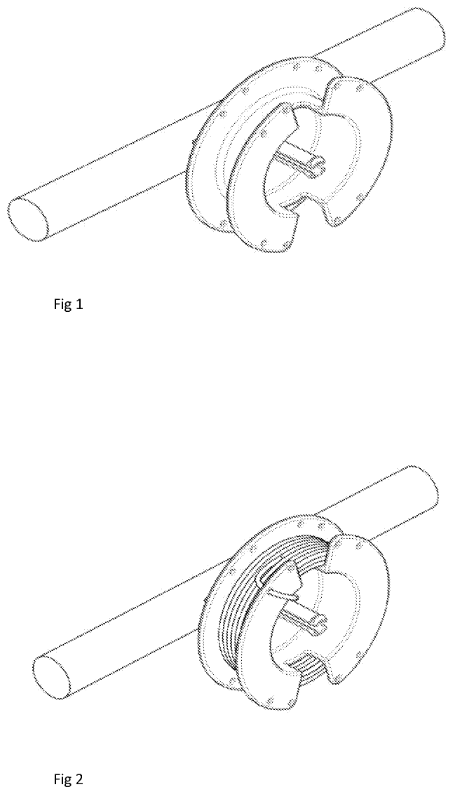

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention is directed to provide a replacement option of the current disintegrated string with new string in an instant manner.

Conventionally, as user cuts grass the string used by the weed eater disintegrates and requires new string be added to the weed eater when all trimmer string has been used. The current assembly allows the weed eater user to access spare weed eater string instantly without the delay and inconvenience associated with replacing weed eater string. This invention ultimately allows weed eater tasks to be completed faster and more efficiently.

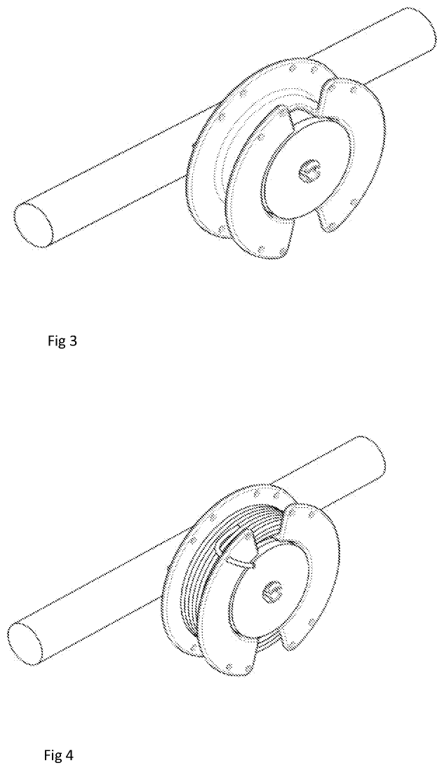

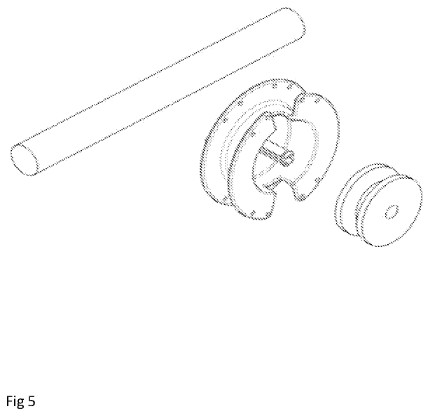

As per preferred embodiments of the invention, a weed eater string holder that is connected to a weed eater and contains surplus weed eater string is proposed. This device holds weed eater string. The user wraps the string around the spool and unwinds the string when ready. The main body of assembly can be attached to any weed eater device as shown in FIG. 3-4 and provides string once required in a convenient manner.

The assembly as per its further embodiments can be holds weed eater string spools that already have the weed eater string applied.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1: A weed eater string holder device comprising:
a string dispenser having a circular frame with a joining handle aimed to be attached to any weed eater's main assembly frame, means on the central frame for supporting string rolls for rotation;
the assembly as per claim 1, holds weed eater string securely;
the assembly as per claim 1, allows user to wrap the string around the spool and unwinds the string when ready; and,
the assembly as per claim 1, is universal in nature and can be attached to any weed eater's main body.

2: A device aimed to hold weed eater string spools which may or may not have the weed eater string applied where the assembly as per claim 1, allows the spool to be attached to the holder and can be removed handily once required.

3: The weed string eater device where:
As per claim 3, the trimmer string holder, holds itself without a string or the spool attached can be seen;
As per claim 3, the trimmer string holder holds, with lose string wrapped around it and without the spool;
As per claim 3, trimmer string holder, holds only the spool of string and without lose string; and,
A device that will hold loose string and pre-strung or empty spools simultaneously.
